(19) United States
(12) Patent Application Publication
(10) Pub. No.: US 2019/0124183 A1
(43) Pub. Date: Apr. 25, 2019

(54) MPTCP PATH SETTING METHOD FOR IMPROVING RELIABILITY

(71) Applicant: ELECTRONICS AND TELECOMMUNICATIONS RESEARCH INSTITUTE, Daejeon (KR)

(72) Inventor: Jong Kuk LEE, Daejeon (KR)

(21) Appl. No.: 16/122,229

(22) Filed: Sep. 5, 2018

(30) Foreign Application Priority Data
Oct. 20, 2017 (KR) 10-2017-0136846

(51) Int. Cl. H04L 29/06; H04L 12/707; H04L 1/18; H04L 5/00; H04L 12/18

(52) U.S. Cl. CPC H04L 69/166; H04L 45/24; H04L 69/163; H04L 12/1868; H04L 5/0055; H04L 65/80; H04L 1/1825

(57) ABSTRACT

A method and apparatus for performing multipath transmission of a data packet. The method includes: setting, by an electronic apparatus performing multipath transmission of a data packet, a multipath network to another electronic apparatus, and setting a re-transmission leased path used for performing packet re-transmission; dividing a data packet into a plurality of sub-packets, and assigning the sub-packets to the multipath network; transmitting the sub-packets by using the assigned multipath; and checking a transmission error of the sub-packet, and re-transmitting the sub-packet in which a transmission error has occurred by using the re-transmission leased path.

### CROSS REFERENCE TO RELATED APPLICATION

The present application claims priority to Korean Patent Application No. 10-2017-0136846, filed Oct. 20, 2017, the entire content of which is incorporated herein for all purposes by this reference.

### BACKGROUND OF THE INVENTION

### 1. Field of the Invention

The present disclosure relates generally to a multipath data transmission method. More particularly, the present disclosure relates to an apparatus and method of controlling multipath transmission of a data packet.

### 2. Description of Related Art

Electronic apparatuses may be provided with various services from another electronic apparatuses or servers by using a communication function. When transmitting and receiving data to/from another electronic apparatuses or servers, an electronic apparatus may generate a plurality of transmission connections by using a multipath transmission function to transmit and receive data. For example, in protocol supporting a multipath transmission function such as multipath transmission control protocol (multipath TCP; MPTCP), stream control transmission protocol (SCTP), etc., for data transmission required from an application, the data may be transmitted by generating a plurality of transmission connections between peer entities and by using the same.

Multipath TCP may divide single connection into various paths so that provide various advantages in terms of improving processing amount and network resource utilization, recovering from a linkage error, etc.

However, when a transmission error occurs in a data packet while transmitting the data packet in a multipath manner, re-transmission of the corresponding data packet is performed by using a path that has been used for transmitting the corresponding data packet. Accordingly, there is a high possibility that a transmission error occurs in a data packet when a network environment of the path where the data packet is transmitted is not stable. As described above, when a network environment of the corresponding path is not stable, a transmission error of a data packet repeatedly occurs, and thus improvements on processing amount and network resource utilization cannot be executed even though transmission is performed using a multipath transmission.

The foregoing is intended merely to aid in the understanding of the background of the present disclosure, and is not intended to mean that the present disclosure falls within the purview of the related art that is already known to those skilled in the art.

### SUMMARY OF THE INVENTION

An object of the present disclosure is to provide a method and apparatus for performing multipath transmission of a data packet, the method and apparatus being capable of performing stable data transmission by setting a retransmission or signaling leased path.

It will be appreciated by persons skilled in the art that the objects that could be achieved with the present disclosure are not limited to what has been particularly described hereinabove and the above and other objects that the present disclosure could achieve will be more clearly understood from the following detailed description.

According to one aspect of the present disclosure, there may be provided a method of performing multipath transmission of a data packet. The method of performing multipath transmission of a data packet may include: setting, by an electronic apparatus performing multipath transmission of a data packet, a multipath network to another electronic apparatus, and setting a re-transmission leased path used for performing packet re-transmission dividing a data packet into a plurality of sub-packets, and assigning the sub-packets to the multipath network; transmitting the sub-packets by using the assigned multipath network and checking a transmission error of the sub-packet, and e-transmitting the sub-packet in which a transmission error has occurred by using the re-transmission leased path.

According to another aspect of the present disclosure, there may be provided an apparatus for performing multipath transmission of a data packet. The apparatus for performing multipath transmission of a data packet may include: a communication unit transmitting and receiving data to/from another electronic apparatus by using a plurality of communication networks; and a control unit setting a multipath network including a re-transmission leased path that is used for packet re-transmission, dividing a data packet into a plurality of sub-packets, transmitting the sub-packets by using the multipath network, checking a transmission error of the sub-packet, and re-transmitting the sub-packet in which the transmission error has occurred by using the re-transmission leased path.

It is to be understood that the foregoing summarized features are exemplary aspects of the following detailed description of the present disclosure without limiting the scope of the present disclosure.

According to the present disclosure, there can be provided a method and apparatus for performing multipath transmission of a data packet, wherein the method and apparatus are capable of stably transmitting a data packet in a multipath manner.

In addition, according to the present disclosure, there can be provided a method and apparatus for performing multipath transmission of a data packet, wherein the method and apparatus are capable of stably and rapidly transmitting a data packet by re-transmitting a data packet in which a transmission error has occurred by using a leased path.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view showing an example of a configuration of a system for performing multipath transmission of a data packet according to various embodiments of the present disclosure.

FIG. 2 is a block diagram showing an example of a detailed configuration of an electronic apparatus according to an embodiment of the present disclosure.

FIGS. 3A to 3C are views showing examples of operation of a system of performing multipath transmission of a data packet according to various embodiments of the present disclosure.

### DETAILED DESCRIPTION OF THE INVENTION

Exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second” etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

In various embodiments below of the present disclosure, an electronic apparatus may be used as terms of “server”, “host”, or “peer”. However, the above terms are employed in the following description for better understanding of the present disclosure. The terms used as an example of the electronic device do not limit the scope of the present disclosure to a specific embodiment.

In addition, in various embodiments below of the present disclosure, as an example of protocol supporting a multipath transmission function to which the present disclosure is applied, transmission protocol of multipath TCP (MPTCP) is used as an example. However, embodiments of the present disclosure are not limited to the MPTCP transmission protocol, the embodiments of the present disclosure may be applied to any protocol supporting a multipath transmission function. For example, the present disclosure may be applied to a protocol supporting various forms of multipath transmission functions such as stream control transmission protocol (SCTP), etc.

Hereinafter, embodiments of the present disclosure will be described with reference to the accompanying drawings.

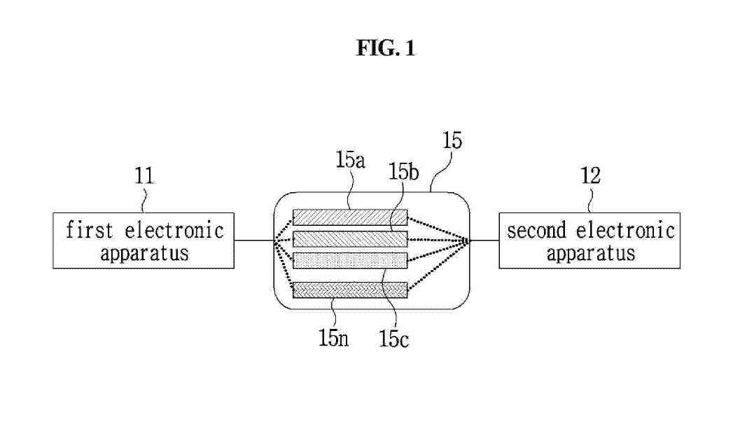

FIG. 1 is a view showing an example of a configuration of a system for performing multipath transmission of a data packet according to various embodiment of the present disclosure. Referring to FIG. 1, according to various embodiments of the present disclosure, a first electronic apparatus 11 and a second electronic apparatus 12 may be connected by using a network 15. For example, when the first electronic apparatus 11 or the second electronic apparatus 12 or both support multipath transmission protocol (for example, MPTCP) function, the first electronic apparatus 11 and the second electronic apparatus 12 may be connected in a multipath manner. Accordingly, the first electronic apparatus 11 may transmit and receive data required by one application to/from the second electronic apparatus 12 by using a plurality of transmission paths set therebetween (for example, wireless fidelity (WiFi) and long term evolution (LTE)).

The network 15 may include at least one wireless communication network or at least one wired communication network, and may provide communication between the server and the electronic apparatus, or between electronic apparatuses. For example, as a wireless communication type, the network 15 may include at least one of WiFi, Bluetooth (BT) near field communication (NFC), global positioning system (GPS) and cellular communication (for example, LTE, LTE-A, CDMA, WCDMA, UMTS, WiBro, or GSM). In addition, as a wired communication type, for example, the network 15 may include at least one of universal serial bus (USB, high definition multimedia interface (HDMI), recommended standard 232 (RS-232) and plain old telephone service (POTS).

For multipath transmission (for example, MPTCP) connection, the first electronic apparatus 11 and the second electronic apparatus 12 receive and transmit SYN, SYN/ACK, and ACK messages including a CAPABLE parameter by using a first network 15a, and thus perform an initial setting process thereof. Herein, the first electronic apparatus 11 may check whether or not the second electronic apparatus 12 supports multipath transmission. In addition, the first electronic apparatus 11 and the second electronic apparatus 12 transmit and receive SYN, SYN/ACK, and ACK messages including a MP_JOIN parameter, and thus perform a sub-flow setting process for multipath transmission. The additional sub-flow setting process for multipath transmission is repeatedly performed by using a third network 15c, . . . and an n-th network 15n so that an additional sub-flow setting process of multipath transmission for a plurality of networks may be performed.

Particularly, when performing the additional sub-flow setting process, the first electronic apparatus 11 and the second electronic apparatus 12 may set a corresponding network (for example, third network 15c) as a re-transmission leased network (or re-transmission leased path). Under the above environment, the first electronic apparatus 11 may transmit a data packet to the second electronic apparatus 12 in a multipath manner. In addition, the second electronic apparatus 12 may check whether or not the received data packet has an error, when an error is present in the corresponding data packet, the second electronic apparatus 12 may request re-transmission of the data packet to the first electronic apparatus 11. In response to this, the first electronic apparatus 11 may re-transmit the data packet that re-transmission thereof is required by using a re-transmission leased network (or re-transmission leased path) (for example, third network 15c).

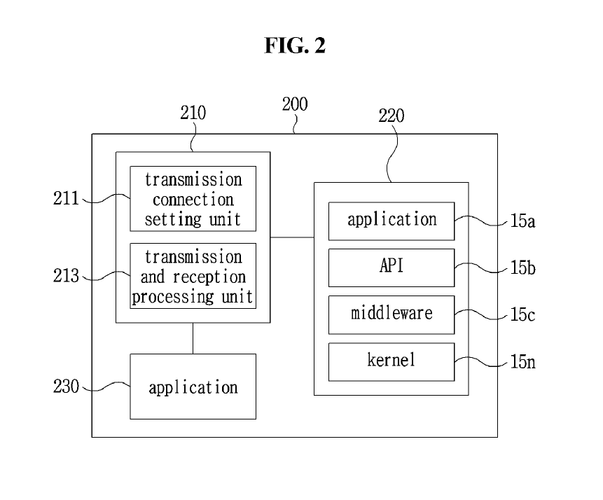

FIG. 2 is a block diagram showing a detailed configuration of an electronic apparatus according to an embodiment of the present disclosure.

Referring to FIG. 2, an electronic apparatus 200 according to an embodiment of the present disclosure may include a control unit 210, a storage unit 220, and a communication unit 230.

The control unit 210 may include a transmission connection setting unit 211, and a transmission and reception processing unit 213, and in the storage unit 220, at least one of an application 221, an API 222, a middleware (for example, framework) 223, and a kernel 224 may be included.

For example, the application 221 stored in the storage unit 220 may be executed and request data to another electronic apparatus outside the electronic apparatus 200. Hereinafter, the electronic apparatus 200 is referred as a ‘first electronic apparatus’ or ‘host A’, and another external electronic apparatus or server is referred as a ‘second electronic apparatus’ or ‘host B’. In various embodiments of the present disclosure, the electronic apparatus may respectively perform host functions, or, any one electronic apparatus may perform a host function and the other electronic apparatus may perform a client function (or, slave apparatus).

Meanwhile, the transmit connection setting unit 211 may perform a setting function for transmission connection from the electronic apparatus 200 to another electronic apparatus. The setting function for transmission connection may be based on, for example, transmission connection operation using TCP protocol. For example, the transmission connection setting unit 211 may receive and transmit from/to another electronic apparatus SYN, SYN/ACK, and ACK messages including a CAPABLE parameter by using a first network, and thus may perform an initial connection setting process. In addition, the transmission connection setting unit 211 may receive and transmit from/to another electronic apparatus SYN, SYN/ACK, and ACK messages including a MP_JOIN parameter by using a second network, a third network, . . . , and an n-th network, and thus may perform an additional sub-flow setting process for multipath transmission.

Particularly, the transmission connection setting unit 211 may set one of networks (or paths) which are set as a multipath network as a re-transmission leased network (or re-transmission leased path). In addition, the transmission connection setting unit 211 may check a re-transmission request of a data packet from the second electronic apparatus based on a transmission error of the data packet, transfer the data packet re-transmission request to the transmission and reception processing unit 213, and control to transmit the corresponding data packet to the second electronic apparatus by using the re-transmission leased network (or re-transmission leased path).

In an embodiment of the present disclosure, an example where the second electronic apparatus transmits a re-transmission request of a data packet to the first electronic apparatus is described. However, the present disclosure is not limited thereto, and may be variably modified. For example, when the first electronic apparatus transmits a data packet, and receives an ACK message from the second electronic apparatus, then the first electronic apparatus may check that the data packet has been normally transmitted. Based on this, the first electronic apparatus may wait an ACK message for a predetermined time, and determine that the corresponding data packet has not been normally transferred to the second electronic apparatus when the ACK message is not received from the second electronic apparatus. Accordingly, the transmission connection setting unit 211 may determine that a transmission error of the data packet has occurred when an ACK message is not received for a predetermined time.

The transmission and reception processing unit 213 may control the communication unit 230 to transmit and receive transmitted and received data packets based on multipath transmission connection setting information provided from the transmission connection setting unit 211.

The communication unit 230 may perform data communication between the electronic apparatus 200 and another external electronic apparatus, and may transmit and receive data based on multipath transmission connection setting information according to a control of the transmission and reception processing unit 213. In addition, the communication unit 230 may include a plurality of communication modules (for example, WiFi module, an LTE module, etc.) for performing multipath transmission according to various embodiment of the present disclosure.

Meanwhile, each functional unit and module in various embodiments of the present disclosure may indicate a functional or structural coupling of hardware for executing a technical idea of various embodiments of the present disclosure and software for operating the hardware. For example, the each functional unit or module may indicate a predetermined code and a unit of logic of a hardware resource for performing the predetermined code. However, it will be understood by a person skilled in the technical field of the present disclosure that the each functional unit does not mean physically connected codes, or a kind of hardware.

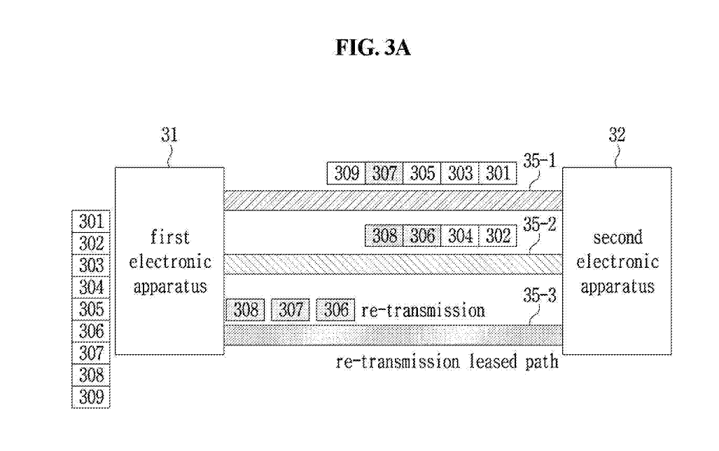

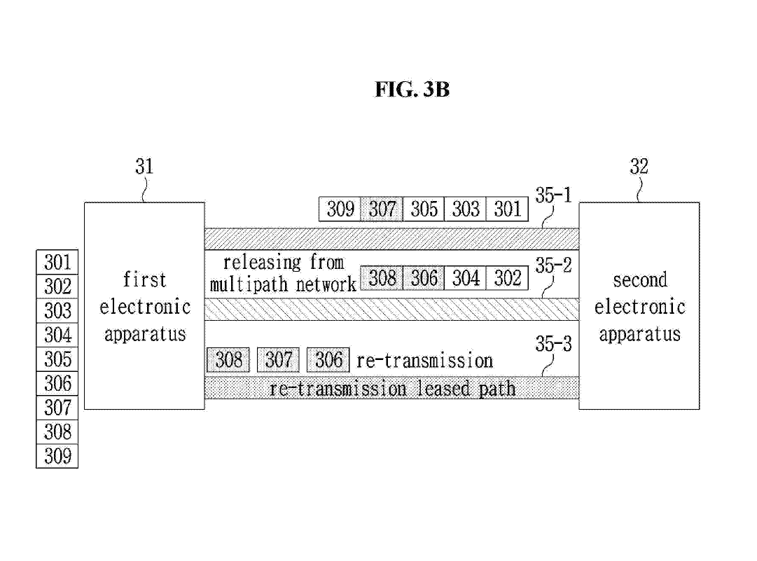

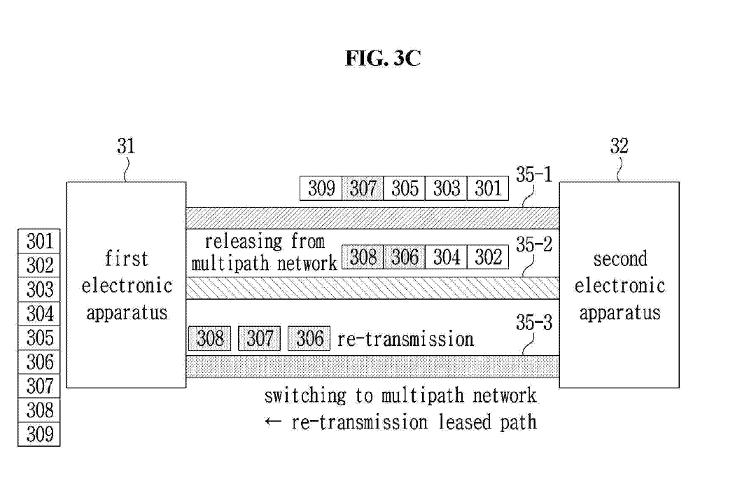

FIGS. 3A to 3C are views showing examples of operation of a system of performing multipath transmission of a data packet according to various embodiments of the present disclosure. Hereinafter, with reference to FIGS. 3A to 3C, detailed operation of an apparatus provided to a system of performing multipath transmission of a data packet according to various embodiments of the present disclosure and the above system will be described.

Referring to FIG. 3A, a first electronic apparatus 31 may perform a function of transmission connection to a second electronic apparatus 32, and set a first path 35-1, a second path 35-2, and a third path 35-3 as a multipath network. In addition, the first electronic apparatus 31 and the second electronic apparatus 32 may set the third path 35-3 as a re-transmission leased path.

The first electronic apparatus 31 assigns a plurality of data packets (first to ninth packets 301-309) to be transmitted to the first path 35-1 and the second path 35-2, and perform transmission of the plurality of data packets (first to ninth packets 301-309) based on the multipath network.

When transmitting the plurality of data packets (first to ninth packets 301-309) to the second electronic apparatus 32, it is assumed that a transmission error occurs in the sixth packet 306, the seventh packet 307, and the eighth packet 308.

The first electronic apparatus 31 may check that a transmission error has occurred in the sixth packet 306, the seventh packet 307, and the eighth packet 308, and assign the packet where a transmission error has occurred, that is, the sixth packet 306, the seventh packet 307, and the eighth packet 308, to the third path 35-3 that is a re-transmission leased path to transmit the same to the second electronic apparatus 32.

Meanwhile, referring to FIG. 3B showing another example, similar to FIG. 3A, a first electronic apparatus 31 may perform a function of transmission connection to a second electronic apparatus 32, and set a first path 35-1, a second path 35-2, and a third path 35-3 as a multipath network. In addition, the first electronic apparatus 31 and the second electronic apparatus 32 may set the third path 35-3 as a re-transmission leased path.

The first electronic apparatus 31 assigns a plurality of data packets (first to ninth packets 301-309) to be transmitted to the first path 35-1 and the second path 35-2, and performs transmission of the plurality of data packets (first to ninth packets 301-309) based on the multipath network.

When transmitting the plurality of data packets (first to ninth packets 301-309) to the second electronic apparatus 32, it is assumed that a transmission error occurs in the sixth packet 306, the seventh packet 307, and the eighth packet 308.

The first electronic apparatus 31 may check that a transmission error has occurred in the sixth packet 306, the seventh packet 307, and the eighth packet 308, and assign the packet where the transmission error has occurred, that is, the sixth packet 306, the seventh packet 307, and the eighth packet 308, to the third path 35-3 that is a re-transmission leased path to transmit the same to the second electronic apparatus 32.

Additionally, the first electronic apparatus 31 checks that a transmission error of the packet (sixth packet 306, the eighth packet 308) has continuously occurred in a specific path, which is the second path 35-2. Accordingly, the first electronic apparatus 31 may determine that an error has occurred in the corresponding path that is the second path 35-2, release the second path 35-2 where an error has occurred from the multipath network, and transmit the packet assigned to the second path 35-2 to the second electronic apparatus 32 by assigning the same to the third path 35-3 that is a re-transmission leased path.

For this, the first electronic apparatus 31 may set a multipath releasing condition, and perform releasing of a corresponding path from the multipath network when a packet transmission error satisfies the multipath releasing condition. For example, a case where transmission errors of a predetermined number of packets or more continuously occur in each path included in the multipath network may be set as the multipath releasing condition.

Referring to FIG. 3C showing another example, similarly to FIG. 3A, a first electronic apparatus 31 may perform a function of transmission connection to a second electronic apparatus 32, and set a first path 35-1, a second path 35-2, and a third path 35-3 as a multipath network. In addition, the first electronic apparatus 31 and the second electronic apparatus 32 may set the third path 35-3 as a re-transmission leased path.

Then, as the example shown in FIG. 3B, when transmitting the plurality of data packets (first to ninth packets 301-309) to the second electronic apparatus 32, a transmission error occurs in the sixth packet 306 and the eighth packet 308 so that the sixth packet 306 and the eighth packet 308 are transmitted by being assigned to the third path 35-3 that is a re-transmission leased path.

Herein, the first electronic apparatus 31 may check that a transmission error of the packet (sixth packet 306, the eighth packet 308) has continuously occurred in a specific path that is the second path 35-2, and releases the corresponding second path 35-2 from the multipath network. Then, different to the example shown in FIG. 3b, the first electronic apparatus 31 switches the released second path 35-2 to the third path 35-3, and the third path 35-3 is released from being set as a re-transmission leased path.

Accordingly, when a transmission error occurs in a packet transmitted through the multipath network, the first electronic apparatus 31 may perform re-transmission of the corresponding packet in which the transmission error has occurred by using the corresponding path. For example, when the released second path 35-2 is switched to the third path 35-3, the third path 35-3 is released from being set as a retransmission leased path, and it has been checked that a transmission error of the seventh packet 307 has occurred in the first path 35-1, the first electronic apparatus 31 may perform re-transmission of the seventh packet 307 by using the third path 35-3.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors) DSPDs (Digital Signal Processing Devices) PLDs (Programmable Logic Devices) FPGAs (Field Programmable Gate Arrays) a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A method of performing multipath transmission of a data packet, the method comprising:
setting, by an electronic apparatus performing multipath transmission of a data packet, a multipath network to another electronic apparatus, and setting a retransmission leased path used for performing packet re-transmission;
dividing a data packet into a plurality of sub-packets, and assigning the sub-packets to the multipath network;
transmitting the sub-packets by using the assigned multipath network; and
checking a transmission error of the sub-packet, and re-transmitting the sub-packet in which the transmission error has occurred by using the re-transmission leased path.

2. The method of claim 1, wherein the re-transmitting of the sub-packet in which the transmission error has occurred includes:
receiving from another electronic apparatus information indicating that the transmission error of the sub-packet has occurred; and
assigning the sub-packet in which the transmission error has occurred to the re-transmission leased path.

3. The method of claim 1, wherein the re-transmitting of the sub-packet in which the transmission error has occurred includes determining that the transmission error of the sub-packet has occurred when an ACK signal is not received from another electronic apparatus for a predetermined time after transmitting the sub-packet.

4. The method of claim 3, wherein the re-transmitting of the sub-packet in which the transmission error has occurred includes assigning the sub-packet in which the transmission error has occurred to the re-transmission leased path.

5. The method of claim 1, father comprising releasing a path corresponding to a path where the transmission error of the sub-packet has occurred from the multipath network.

6. The method of claim 5, further comprising assigning the sub-packet assigned to the released path to the re-transmission leased path.

7. The method of claim 5, wherein the releasing of the corresponding path from the multipath network includes checking whether or not the corresponding path satisfies a predetermined condition, wherein the method further includes releasing the corresponding path satisfying the predetermined condition from the multipath network.

8. An apparatus for performing multipath transmission of a data packet, the apparatus comprising:
a communication unit transmitting and receiving data to/from another electronic apparatus by using a plurality of communication networks; and
a control unit setting a multipath network including a re-transmission leased path that is used for packet re-transmission, dividing a data packet into a plurality of sub-packets, transmitting the sub-packets by using the multipath network, checking a transmission error of the sub-packet, and re-transmitting the sub-packet in which the transmission error has occurred by using the re-transmission leased path.

9. The apparatus of claim 8, wherein the control unit includes: a transmission connection setting unit setting a multipath network including at least one transmission path supporting multipath transmission and a re-transmission leased path used for packet re-transmission; and a transmission and reception processing unit assigning the plurality of sub-packets to at least one transmission path, and transmitting the sub-packet in which the transmission error has occurred by assigning the same to the retransmission leased path.

10. The apparatus of claim 9, wherein the transmission connection setting unit receives information indicating that the transmission error of the sub-packet has occurred from another electronic apparatus, and assigns the sub-packet in which the transmission error has occurred to the re-transmission leased path.

11. The apparatus of claim 9, wherein the transmission connection setting unit determines that the transmission error of the sub-packet has occurred when an ACK signal is not received from another electronic apparatus for a predetermined time after transmitting the sub-packet to another electronic apparatus.

12. The apparatus of claim 11, wherein the transmission connection setting unit assigns the sub-packet in which the transmission error has occurred to the re-transmission leased path.

13. The apparatus of claim 9, wherein the transmission connection setting unit releases a path corresponding to a path where the transmission error of the sub-packet has occurred from the multipath network.

14. The apparatus of claim 13, wherein the transmission connection setting unit assigns the sub-packet assigned to the released path to the re-transmission leased path.

15. The apparatus of claim 13, wherein the transmission connection setting unit checks whether or not the corresponding path satisfies a predetermined condition, and releases the corresponding path satisfying the predetermined condition from the multipath.
